(19) United States
(12) Patent Application Publication
(10) Pub. No.: US 2025/0078038 A1
(43) Pub. Date: Mar. 6, 2025

(54) BACKGROUND CHECK DATA CO-OP SYSTEM

(71) Applicant: Isotalent Inc., Lehi, UT (US)

(72) Inventors: Robb Lifferth, Lehi, UT (US); Paul Ahlstrom, Lehi, UT (US)

(21) Appl. No.: 18/825,587

(22) Filed: Sep. 5, 2024

Related U.S. Application Data
(60) Provisional application No. 63/580,455, filed on Sep. 5, 2023.

(51) Int. Cl. G06Q 10/1053

(52) U.S. Cl. CPC G06Q 10/1053

(57) ABSTRACT

Methods, systems, and apparatuses for a background check data co-op platform. A method includes receiving, from a verified, trusted third party (VTTP) computing system, validation data associated with a qualification included in a digital work wallet of a job seeker, and determining, based on the qualification, that the qualification is a static qualification. The method further includes, based on the determination that the qualification is a static qualification, storing, in the digital work wallet based on the validation data, an indication that the qualification is validated. The method further includes, based on receipt of a request to submit an application for a job by the job seeker, sending the digital work wallet with the indication that the qualification is validated to an employer system associated with the job.

### CROSS REFERENCE TO RELATED PATENT APPLICATION

This application claims priority to U.S. Provisional Application No. 63/580,455 filed Sep. 5, 2023, which is herein incorporated by reference in its entirety.

### BACKGROUND

Management of recruitment processes involves employers, recruiting agents, and jobseekers. Frequently, recruitment of candidates by employers (e.g., hiring companies or other entities) for specific jobs (e.g., roles, positions, etc.) is manually driven and is limited to direct contact (e.g., through applying for a job) from a candidate or contact through recruiters. For efficiency purposes, rather than running background checks on all candidates, background checks are often deferred until later in the hiring process, such as after a candidate has been offered and has accepted a position. However, waiting until this step in the process result in loss of other qualified candidates if the background check for a candidate comes back as disqualifying for one reason or another. This deficiency can extend the recruitment process timeline to fill a role.

### SUMMARY

It is to be understood that both the following general description and the following detailed description are exemplary and explanatory only and are not restrictive. This application describes examples of a background check data co-op platform (BCDCP) to identify and re-use various data points identified in a background check process when for job candidates. In the BCDCP platform, various data points, may be defined as either static or non-static data, with each type of data having varying levels of usefulness based on the data category and timelines. The BCDCP may provide differentiated value to both the background check holder (e.g., background request target, such as a job seeker) and background check requesters (e.g., employers). For example, the BCDCP may benefit participating background check holder by allowing the holder to own their background check data in a way that will be portable to them for as long as they are members of the BCDCP platform, and may provide a single repository to hold all data related to any training, education, professional certifications, personality and skill assessments, work history or residential history. The BCDCP may benefit any the background check requestor by reducing an amount of time it takes to run parts of the background check (e.g., which can sometimes take several days/weeks to complete), and may reduce risk and cost of the data that has already been verified while still being able to trust the data collection origins.

Other examples are possible as well. Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 illustrates a block diagram of a system for managing recruitment processes among job seekers (e.g., candidates) and employers in accordance with embodiments described herein.

FIG. 2 illustrates a block diagram of a system for managing recruitment processes among job seekers (e.g., candidates) and employers in accordance with embodiments described herein.

FIG. 3 illustrates a block diagram of a CMCP, in accordance with embodiments described herein.

FIG. 4 illustrates a block diagram of a BCDCP system, in accordance with embodiments described herein.

FIG. 5 is a block diagram depicting a system/environment in accordance with embodiments of the disclosure.

FIG. 6 depicts a flowchart of an example method to manage validation of job seeker qualifications via a BCDCP in accordance with embodiments of the disclosure.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The method steps recited throughout this disclosure may be combined, omitted, rearranged, or otherwise reorganized with any of the figures presented herein and are not intended to be limited to the four corners of each sheet presented. The techniques disclosed herein may be implemented on a computing device(s) in a way that improves performance and/or efficiency of operation, as further described herein.

The present disclosure describes an Artificial Intelligence (AI) based BCDCP that maintains independently verified data for job seekers in a digital work wallet (e.g., a digital resume, digital work history, digital curriculum vitae, etc.), which may be provided to prospective employers with a job application to provide further assurances as to the qualifications of a prospective candidate for a role.

As used herein, ‘AI-module’ or ‘machine learning inference’ is an artificial intelligence enabled device or module, that is capable of processing digital logics and also possesses analytical skills for analyzing and processing various data or information, according to the embodiments of the present invention.

As used herein, ‘data storage’ refers to a local or remote memory device; docket systems; storage units; databases; each capable to store information including, voice data, speech to text transcriptions, customer profiles and related information, audio feeds, metadata, predefined events, call notes, etc. In an embodiment, the storage unit may be a database server, a cloud storage, a remote database, a local database.

As used herein, ‘device’ or ‘system’ may refer to a device, a system, a hardware, a computer application configured to execute specific functions or instructions according to the embodiments of the present invention. The module or unit may include a single device or multiple devices configured to perform specific functions according to the present invention disclosed herein.

Terms such as ‘connect’, ‘integrate’, ‘configure’, and other similar terms include a physical connection, a wireless connection, a logical connection or a combination of such connections including electrical, optical, RF, infrared, Bluetooth, or other transmission media, and include configuration of software applications to execute computer program instructions, as specific to the presently disclosed embodiments, or as may be obvious to a person skilled in the art.

Terms such as ‘send’, ‘transfer’, ‘transmit’ and ‘receive’, ‘collect’, ‘obtain’, ‘access’ and other similar terms refers to transmission of data between various modules and units via wired or wireless connections across a network. The ‘network’ includes a local area network (LAN), a wide area network (WAN), a metropolitan area network (MAN), a virtual private network (VPN), an enterprise private network (EPN), Internet, cloud-based network, and a global area network (GAN).

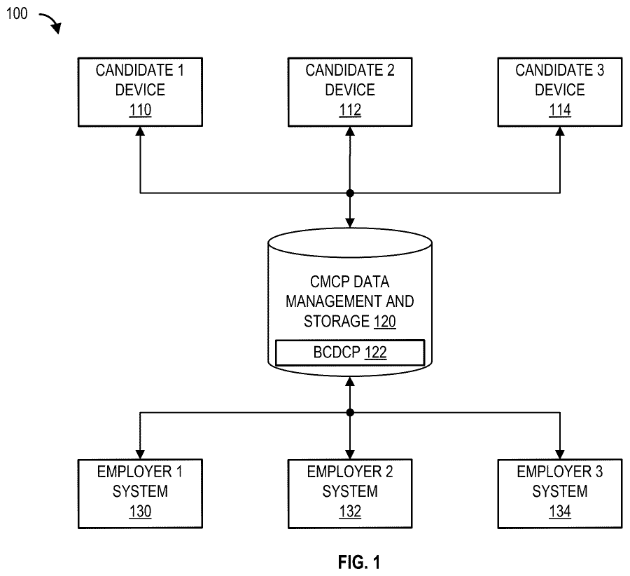

FIG. 1 illustrates a block diagram of a system 100 for managing recruitment processes among job seekers (e.g., candidates) and employers in accordance with embodiments described herein. The system 100 may include candidate devices 110, 112, and 114, a CMCP data management and storage system 120 with BCDCP 122, and employer systems 130, 132, and 134. The candidate devices 110, 112, and 114, the CMCP data management and storage system 120, and employer systems 130, 132, and 134 may be in communication over a network (e.g., any wireless or wired network, or combination thereof). The candidate devices 110, 112, and 114 may be associated with one or more job seekers or candidates.

The candidate devices 110, 112, and 114 may be operated by one or more job seekers to communicate with the employer systems 130, 132, and 134 to apply for jobs, retrieve job status, etc. The candidate devices 110, 112, and 114 may also communicate with the CMCP data management and storage system 120 to store and retrieve personal information, job posting information, and other information managed by the CMCP data management and storage system 120.

The employer systems 130, 132, and 134 may be operated by one or more employers to communicate with the candidate devices 110, 112, and 114 to provide job listing information, receive applications for jobs, retrieve job status, etc. The employer systems 130, 132, and 134 may also communicate with the CMCP data management and storage system 120 to store and retrieve candidate information, recommendations of qualified candidates, update job posting status, and other information managed by the CMCP data management and storage system 120.

The CMCP data management and storage system 120 may be communicatively associated with data storage that stores various data and information pertaining to the management of recruitment of a candidate. In some examples, the data and information stored in the data storage may be collected from employers via the employer systems 130, 132, and 134 and/or an applicant tracking system that agree to participate in the CMCP data management and storage system 120, and may include data related to all candidates applying for any of their open positions. In return for participating in the CMCP data management and storage system 120, the employers may be able to glean valuable information from the data related to a role they are posting, such as what percent of qualified job seekers in the CMCP data management and storage system 120 are actively seeking, passively seeking, or not on the market. In addition, they may gain insight into how long similar positions take to fill, with and without recruiter assistance. Hiring companies in the co-op may also receive recommendations including a limited list of top candidates based on qualification scores, candidates that list themselves as “Actively Seeking” with the option to invite them to apply.

Additionally or alternatively, the data and information stored in the data storage may be collected from job seekers via the candidate devices 110, 112, and 114 that agree to participate in the CMCP data management and storage system 120, and may include information and assessment results with hiring companies participating in the CMCP 222. In some examples, the job seekers may elect to restrict dissemination of their information to certain employers. In some examples, the job seekers may receive recommendations to apply for open positions that the candidates have a high related qualification score or they can opt-in to recommendations for specific positions that they have an interest in but may not have a competitive qualification score. Job Seekers may also gain visibility into what companies are interested in their skillset and are pursuing them as a candidate.

For employers, implementation of the CMCP data management and storage system 120 may lead to increased size of a candidate pool for a job opening, improve visibility into expected TTF for the job opening, and suggest qualified candidates to employers for the job opening. For job seekers, implementation of the CMCP data management and storage system 120 may provide job opening suggestions for roles that fit the candidates qualifications and provide visibility to employers that are looking to fill open roles.

The CMCP data management and storage system 120 may generate candidate profile data, job profile data, and industrial profile data. The candidate profile data may include, for example, name and contact details of all candidates who are registered to use the CMCP data management and storage system 120. The candidate profile data may also include a digital work wallet (e.g., or other information related to qualifications) of the respective candidates. In some examples, the digital work wallet may be managed by the BCDCP 122.

The job profile data may include, for example, details of various job positions, job types, job location etc. the industry profile data may include for example profile of the companies and recruiters who are registered to use the CMCP data management and storage system 120 for hiring a candidate. Further, prediction of time to fill a position by a candidate, based on one or more parameters including location, salary, and skill set may also be determined.

The CMCP data management and storage system 120 may include a machine learning inference that calculates scores for various candidates according to their profile for respective jobs. The candidate scoring system may also configured to assign ranking to various candidates based on the scores calculated.

The CMCP data management and storage system 120 may also include a machine learning inference to calculate the scores and ranking with respect to a job position. The CMCP data management and storage system 120 may further include a recommendation system that is configured to define one or more parameters and predict the hiring probability results offer candidates. Based on the calculated candidate and job scores, the recommendation system may provide a recommendation to the candidates via the candidate devices 110, 112, and 114 and employers via the employer systems 130, 132, and 134.

In some examples, the BCDCP 122 may generate and maintain the certified digital work wallet including certifications/memberships, employment history, education history, skills/assessments test results, validate residential history, employment history, certification/memberships, skills/assessments test results, etc., via a verified trusted third party (VTTP), and/or store the validation in the data storage. In some examples, the job seeker may also provide to the BCDCP 122 background checks ran by previous background check companies, clearing houses, or other VTTPs. This data may be made available by the BCDCP 122 in their digital work wallet and may be provided to an employer at the discretion of the job seeker (e.g., as governed by any local or national governing laws and regulations).

Thus, when the job seeker applies to a job, the validated work history and achievements may be deemed “certified” through a predetermined validation process via a VTTP. In some examples, the data stored in the digital work wallet may be divided into static data and non-static data by the BCDCP 122. Static data type may include information that does not change over time, such as previous employment history, previous education history, certifications or memberships without expiration dates, skill assessments, previous residential history. That is, once static data is authenticated, the authentication will remain valid going forward. Non-static data may include information that tends to become outdated, expire become stale, etc., such as criminal history, financial/credit checks, certifications with expiration dates, recent work history after a previous verification check, recent education history after a previous verification check, recent residential history after a previous verification check.

In addition, the BCDCP 122 may also receive the verification data or reports associated with the job seeker that are provided from the VTTP, such as a background check performed for a previous application, employment history verification, residence history verification, drug test history, criminal reports, etc. In some examples, a respective verification report for each piece of static data may be stored with the candidate profile data, and may be provided upon request by a prospective employer (e.g., with the candidate's permission) or the candidate. When a candidate applies for a job, the BCDCP 122 may provide the static data along with the job candidate's other qualifications. This static information that has been verified may be identified or marked to provide notice of the verification to a prospective employer. Upon request of the candidate or the prospective employer (along with consent of the candidate), updated non-static data may be requested. Once provided to the BCDCP 122, the updated non-static data may be received by the BCDCP 122 and the digital work wallet may be updated with the new non-static information. During this process, some static verification information may also be received, such as updated employment history for more recent jobs, updated residential history, updated education history, updated certifications or memberships without expiration.

In some examples, the CMCP data management and storage system 120 may selectively organize the digital work wallet for a job seeker when applying for a role to highlight skills that are relevant to the role, such as placing information most relevant to skills desired for the role earlier in the application. This functionality may be enabled and performed by a machine learning inference.

In some examples, the CMCP data management and storage system 120 may provide the job seeker with a partial or full history of any application(s) that have been submitted inside the ecosystem of the CMCP data management and storage system 120. The job application history may include status updates and various feedback mechanisms, which can be automated and/or entered manually by anyone in the job application or interview process that has appropriate access.

The CMCP data management and storage system 120 may also include a “data co-op” style compensation data analytics tool (CDA). To participate in the CDA, the job seeker must be willing to share certain aspects of their compensation to a larger pool of data with correlating data that will identify the seniority and type of role that is correlated to their compensation, but may allow the identity of the job seeker to remain anonymous.

Various aspects of the CMCP data management and storage system 120 may be shared with other members of the CMCP data management and storage system 120 ecosystem. The level and definitions of which data will be shared may be outlined in a governing policy, such as a “Terms and Conditions” policy but not limited to any document. The level of data available to be shared to other members of the CMCP data management and storage system 120 ecosystem may be controlled and throttled at various degrees at the discretion of the job seeker and the governing documents of the CMCP data management and storage system 120 governing documentation. In some examples, one benefit of the data co-op enabled by the CMCP data management and storage system 120 is that it enhances a value of the job seeker's career along their career journey.

In some examples, to participate in data co-op operated by the CMCP data management and storage system 120, the job seeker may agree to a data contract ownership to maximize the reciprocal value of the job seeker and the CMCP data management and storage system 120 to help manage their career as well as job applications, background checks, and other valuable information in the employment process. The job seeker may retain ownership of their data (e.g., including their digital work wallet), and can withdraw it at any time. The data may be designed to be portable from job to job.

In some examples, the CMCP data management and storage system 120 may analyze a job seeker's data (e.g., work history, educational history, certifications/memberships, skills, etc.) and may provide feedback to the job seeker. For example, the CMCP data management and storage system 120 may identify a skill gap for a type of role the job seeker is pursuing. The skill gap may be related to particular experience, a certification, some sort of education, etc. In other examples, the CMCP data management and storage system 120 may generate short and long term goals for a candidate that is pursuing promotion to a higher level job (or a job in a different discipline or industry). The short and long term goals may include types of work experience or roles, education, certifications, etc., that people in the higher level job typically have. In addition, the CMCP data management and storage system 120 may identify an amount of experience, etc., that the job seeker in each role to acquire the requisite skills for the higher level job. In some examples, based on a job seeker acquiring a threshold amount of experience in a role, the CMCP data management and storage system 120 may notify a job seeker that they should consider pursuing the next role on their path to the higher level job. This functionality may be enabled and performed by a machine learning inference.

As disclosed above, the CMCP data management and storage system 120 may include an artificial intelligence (AI) module with machine learning capabilities to keep learning with each candidate, the data that is gathered throughout the process and thereby to improve accuracy of the prediction by the CMCP data management and storage system 120. The AI module may be configured to gather data from the candidate devices 110, 112, and 114 and/or the employer systems 130, 132, and 134.

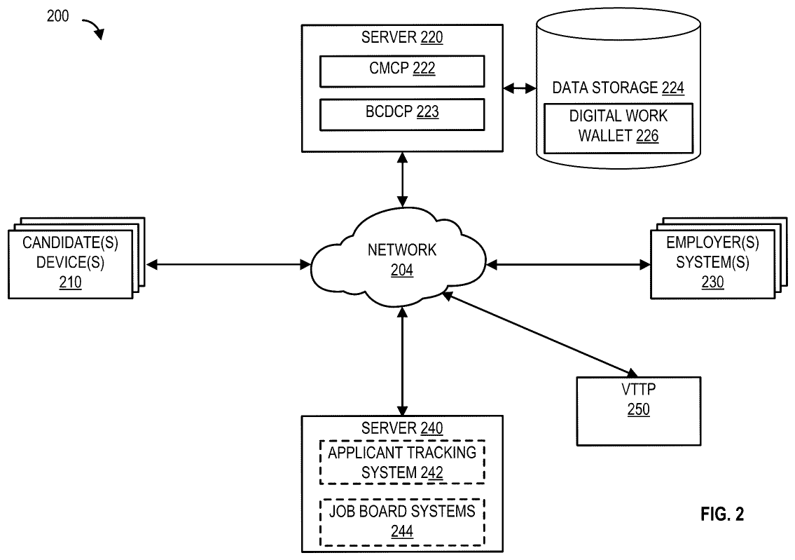

FIG. 2 illustrates a block diagram of a system 200 for managing recruitment processes among job seekers (e.g., candidates) and employers in accordance with embodiments described herein. The CMCP data management and storage 120 of FIG. 1 may implement the CMCP 222 in some examples. The BCDCP 122 of FIG. 1 may implement the BCDCP 224, in some examples. The system 200 may include one or more candidate devices 210, a server 220 configured to host a CMCP 222 and a BCDCP 224 and coupled to data storage 224, one or more servers 240 configured to optionally host an applicant tracking system (ATS) 242 and/or a job board system 244, one or more employer systems 230, and one or more verified, trusted third party verification systems (VTTP) 250. The one or more candidate devices 210, the server 220, the one or more servers 240, and the one or more employer systems 230 may be in communication over a network 204. The network 104 may include any wireless or wired network, or combination thereof. The one or more candidate devices 210 may be associated with one or more job seekers or candidates. The data storage 224 may store user profile data, job profile data, industry profile data, etc.

The one or more candidate devices 210 may be operated by one or more job seekers to communicate with the one or more employer systems 230 to apply for jobs, retrieve job status, etc. The one or more candidate devices 210 may also communicate with the CMCP 222 to store and retrieve personal information, job posting information, and other information managed by the CMCP 222. The one or more candidate devices 210 may also communicate with the job board system 244 to view job postings and apply for posted jobs.

The one or more employer systems 230 may be operated by one or more employers to communicate with the one or more candidate devices 210 to provide job listing information, receive applications for jobs, retrieve job status, etc. The one or more employer systems 230 may also communicate with the CMCP 222 to store and retrieve candidate information, recommendations of qualified candidates, update job posting status, and other information managed by the CMCP 222. The one or more employer systems 230 may also communicate with the ATS 242 to provide or receive applicant information and/or the job board system 244 to provide job postings and receive candidate applications, provide to store and retrieve candidate information, recommendations of qualified candidates, update job posting status, and other information managed by the CMCP 222.

The ATS 242 may aggregate candidate information from the one or more employer systems 230 and serve as a repository candidate pool for future job postings. The job board system 244 may act as an interface between employers and job seekers to facilitate filling of posted jobs.

The CMCP 222 may be communicatively associated with the data storage 224, that stores various data and information pertaining to the management of recruitment of a candidate. In some examples, the data and information stored in the data storage 224 may be collected from employers via the one or more employer systems 230 and/or the ATS 242 that agree to participate in the CMCP 222, and may include data related to all candidates applying for any of their open positions. In return for participating in the CMCP 222, the employers may be able to glean valuable information from the data related to a role they are posting, such as what percent of qualified job seekers in the CMCP 222 are actively seeking, passively seeking, or not on the market. In addition, they may gain insight into how long similar positions take to fill, with and without recruiter assistance. Hiring companies in the co-op may also receive recommendations including a limited list of top candidates based on qualification scores, candidates that list themselves as “Actively Seeking” with the option to invite them to apply.

Additionally or alternatively, the data and information stored in the data storage 224 may be collected from job seekers via the one or more candidate devices 210 that agree to participate in the CMCP 222, and may include information and assessment results with hiring companies participating in the CMCP 222. In some examples, the job seekers may elect to restrict dissemination of their information to certain employers. In some examples, the job seekers may receive recommendations to apply for open positions that the candidates have a high related qualification score or they can opt-in to recommendations for specific positions that they have an interest in but may not have a competitive qualification score. Job Seekers may also gain visibility into what companies are interested in their skillset and are pursuing them as a candidate.

For employers, implementation of the CMCP 222 may lead to increased size of a candidate pool for a job opening, improve visibility into expected TTF for the job opening, and suggest qualified candidates to employers for the job opening. For job seekers, implementation of the CMCP 222 may provide job opening suggestions for roles that fit the candidates qualifications and provide visibility to employers that are looking to fill open roles.

The CMCP 222 may generate candidate profile data, job profile data, and industrial profile data. The candidate profile data may include, for example, name and contact details of all candidates who are registered to use the CMCP 222. The candidate profile data may also include a digital work wallet (e.g., or other information related to qualifications) 226 of the respective candidates managed by the BCDCP 224.

The job profile data may include, for example, details of various job positions, job types, job location etc. the industry profile data may include for example profile of the companies and recruiters who are registered to use the CMCP 222 for hiring a candidate. Further, prediction of time to fill a position by a candidate, based on one or more parameters including location, salary, and skill set may also be determined.

In some examples, the BCDCP 224 may generate and maintain the certified digital work wallet 226 including certifications/memberships, employment history, education history, skills/assessments test results, validate residential history, employment history, certification/memberships, skills/assessments test results, etc., via the one or more VTTPs 250, and/or store the validation in the data storage. In some examples, the job seeker may also provide to the BCDCP 224 background checks ran by previous background check companies, clearing houses, or others of the one or more VTTPs 250. This data may be made available by the BCDCP 224 in their digital work wallet 226 and may be provided to an employer at the discretion of the job seeker (e.g., as governed by any local or national governing laws and regulations).

Thus, when the job seeker applies to a job, the validated work history and achievements may be deemed “certified” through a predetermined validation process via the one or more VTTPs 250. In some examples, the data stored in the digital work wallet 226 may be divided into static data and non-static data by the BCDCP 224. Static data type may include information that does not change over time, such as previous employment history, previous education history, certifications or memberships without expiration dates, skill assessments, previous residential history. That is, once static data is authenticated, the authentication will remain valid going forward. Non-static data may include information that tends to become outdated, expire become stale, etc., such as criminal history, financial/credit checks, certifications with expiration dates, recent work history after a previous verification check, recent education history after a previous verification check, recent residential history after a previous verification check. For example, a job seeker with an accounting background can enter their CPA certification into the BCDCP 224 through the one or more VTTPs 250. A CPA certification may be considered static data, since they will always have the CPA at one point in time. Alternatively, the CPA certification status (e.g., active or inactive), according to the outlined requirements of the CPA governing body may be considered non-static.

In addition, the BCDCP 224 may also receive the verification data or reports associated with the job seeker that are provided from the one or more VTTPs 250, such as a background check performed for a previous application, employment history verification, residence history verification, drug test history, criminal reports, etc. In some examples, a respective verification report for each piece of static data may be stored with the candidate profile data, and may be provided upon request by a prospective employer (e.g., with the candidate's permission) or the candidate. When a candidate applies for a job, the BCDCP 224 may provide the static data along with the job candidate's other qualifications. This static information that has been verified may be identified or marked to provide notice of the verification to a prospective employer. Upon request of the candidate or the prospective employer (along with consent of the candidate), updated non-static data may be requested. Once provided to the BCDCP 224, the updated non-static data may be received by the BCDCP 224 and the digital work wallet 226 may be updated with the new non-static information. During this process, some static verification information may also be received, such as updated employment history for more recent jobs, updated residential history, updated education history, updated certifications or memberships without expiration.

The CMCP 222 may include a machine learning inference that calculates scores for various candidates according to their profile for respective jobs. The candidate scoring system may also configured to assign ranking to various candidates based on the scores calculated.

The CMCP 222 may also include a machine learning inference to calculate the scores and ranking with respect to a job position. The CMCP 222 may further include a recommendation system that is configured to define one or more parameters and predict the hiring probability results offer candidates. Based on the calculated candidate and job scores, the recommendation system may provide a recommendation to the candidates via the one or more candidate devices 210 and employers via the one or more employer systems 230.

In some examples, the CMCP 222 may provide the job seeker with a partial or full history of any application(s) that have been submitted inside the ecosystem of the CMCP 222. The job application history may include status updates and various feedback mechanisms, which can be automated and/or entered manually by anyone in the job application or interview process that has appropriate access.

The CMCP 222 may also include a “data co-op” style compensation data analytics tool (CDA). To participate in the CDA, the job seeker must be willing to share certain aspects of their compensation to a larger pool of data with correlating data that will identify the seniority and type of role that is correlated to their compensation, but may allow the identity of the job seeker to remain anonymous.

Various aspects of the CMCP 222 may be shared with other members of the CMCP 222 ecosystem. The level and definitions of which data will be shared may be outlined in a governing policy, such as a “Terms and Conditions” policy but not limited to any document. The level of data available to be shared to other members of the CMCP 222 ecosystem may be controlled and throttled at various degrees at the discretion of the job seeker and the governing documents of the CMCP 222 governing documentation. In some examples, one benefit of the data co-op enabled by the CMCP 300 is that it enhances a value of the job seeker's career along their career journey.

In some examples, to participate in data co-op operated by the CMCP 222, the job seeker may agree to a data contract ownership to maximize the reciprocal value of the job seeker and the CMCP 222 to help manage their career as well as job applications, background checks, and other valuable information in the employment process. The job seeker may retain ownership of their data, and can withdraw it at any time. The data may be designed to be portable from job to job.

In some examples, the CMCP 222 may analyze a job seeker's data (e.g., work history, educational history, certifications/memberships, skills, etc.) and may provide feedback to the job seeker. For example, the CMCP 222 may identify a skill gap for a type of role the job seeker is pursuing. The skill gap may be related to particular experience, a certification, some sort of education, etc. In other examples, the CMCP 222 may generate short and long term goals for a candidate that is pursuing promotion to a higher level job (or a job in a different discipline or industry). The short and long term goals may include types of work experience or roles, education, certifications, etc., that people in the higher level job typically have. In addition, the CMCP 222 may identify an amount of experience, etc., that the job seeker in each role to acquire the requisite skills for the higher level job. In some examples, based on a job seeker acquiring a threshold amount of experience in a role, the CMCP 222 may notify a job seeker that they should consider pursuing the next role on their path to the higher level job. This functionality may be enabled and performed by a machine learning inference.

As disclosed above, the CMCP 222 may include an artificial intelligence (AI) module with machine learning capabilities to keep learning with each candidate, the data that is gathered throughout the process and thereby to improve accuracy of the prediction by the CMCP 222. The AI module may be configured to gather data from the ATS 242, the job board system 244, the one or more candidate devices 210, and/or the one or more employer systems 230.

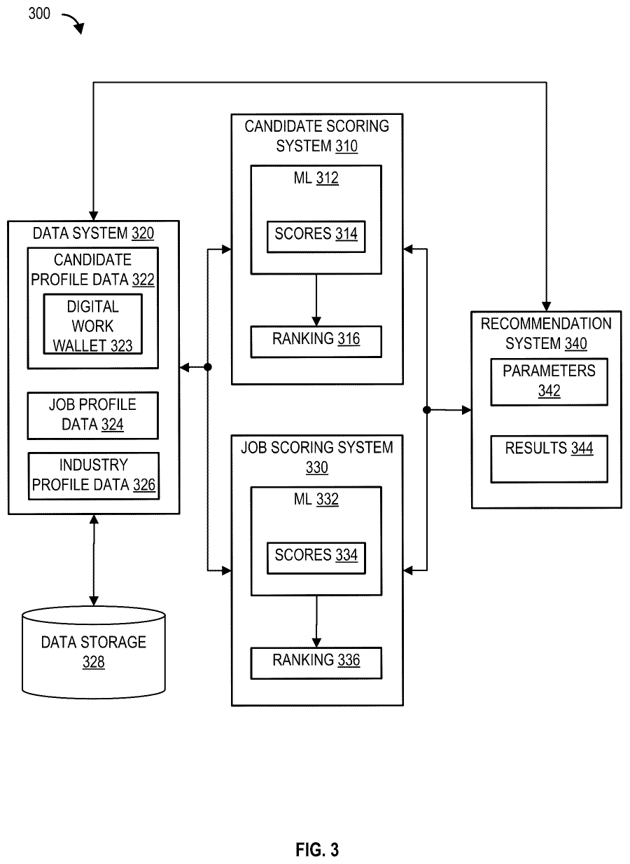

FIG. 3 illustrates a block diagram of a CMCP and BCDCP 300, in accordance with embodiments described herein. The CMCP data management and storage 120 and the BCDCP 122 of FIG. 1 and/or the CMCP 222 and BCDCP 224 of FIG. 2 may implement the CMCP and BCDCP 300 in some examples. The CMCP and BCDCP 300 may include a data system 320, a candidate scoring system 310, a job scoring system 330, and recommendation system 340. The various components of the CMCP 300 may be communicatively associated with the data storage 328, that stores various data and information pertaining to the management of recruitment of a candidate. In some examples, the data and information stored in the data storage 328 may be collected from employers that agree to participate in the CMCP and BCDCP 300, and may include data related to all candidates applying for any of their open positions. In return for participating in the CMCP and BCDCP 300, the employers may be able to glean valuable information from the data related to a role they are posting, such as what percent of qualified job seekers in the CMCP and BCDCP 300 are actively seeking, passively seeking, or not on the market. In addition, they may gain insight into how long similar positions take to fill, with and without recruiter assistance. Hiring companies in the co-op may also receive recommendations including a limited list of top candidates based on qualification scores, candidates that list themselves as “Actively Seeking” with the option to invite them to apply.

Additionally or alternatively, the data and information stored in the data storage 328 may be collected from job seekers that agree to participate in the CMCP and BCDCP 300, and may include information and assessment results with hiring companies participating in the CMCP and BCDCP 300. In some examples, the job seekers may elect to restrict dissemination of their information to certain employers. In some examples, the job seekers may receive recommendations to apply for open positions that the candidates have a high related qualification score or they can opt-in to recommendations for specific positions that they have an interest in but may not have a competitive qualification score. Job Seekers may also gain visibility into what companies are interested in their skillset and are pursuing them as a candidate.

The data system 320 may generate candidate profile data 322, job profile data 324, and industrial profile data 326. The candidate profile data 322 may include, for example, name and contact details of all candidates who are registered to use the CMCP 300. The candidate profile data 322 also includes a digital work wallet (e.g., or other information related to qualifications) 323 of the respective candidates. The digital work wallet 323 may be managed by the data system 320. The job profile data 324 may include, for example, details of various job positions, job types, job location etc. the industry profile data may include for example profile of the companies and recruiters who are registered to use the CMCP and BCDCP 300 for hiring a candidate. Further, prediction of time to fill a position by a candidate, based on one or more parameters 342 including location, salary, and skill set may also be determined.

In some examples, the data system 320 may generate and maintain the certified digital work wallet 323 including certifications/memberships, employment history, education history, skills/assessments test results, validate residential history, employment history, certification/memberships, skills/assessments test results, etc., via VTTP, and/or store the validation in the data storage. In some examples, the job seeker may also provide to the data system 320 background checks ran by previous background check companies, clearing houses, or other VTTPs. This data may be made available by the data system 320 in their digital work wallet 323 and may be provided to an employer at the discretion of the job seeker (e.g., as governed by any local or national governing laws and regulations).

Thus, when the job seeker applies to a job, the validated work history and achievements may be deemed “certified” through a predetermined validation process via a VTTP. In some examples, the data stored in the digital work wallet 323 may be divided into static data and non-static data by the data system 320. Static data type may include information that does not change over time, such as previous employment history, previous education history, certifications or memberships without expiration dates, skill assessments, previous residential history. That is, once static data is authenticated, the authentication will remain valid going forward. Non-static data may include information that tends to become outdated, expire become stale, etc., such as criminal history, financial/credit checks, certifications with expiration dates, recent work history after a previous verification check, recent education history after a previous verification check, recent residential history after a previous verification check. For example, a job seeker with an accounting background can enter their CPA certification into the data system 320 through a VTTP. A CPA certification may be considered static data, since they will always have the CPA at one point in time. Alternatively, the CPA certification status (e.g., active or inactive), according to the outlined requirements of the CPA governing body may be considered non-static.

In addition, the data system 320 may also receive the verification data or reports associated with the job seeker that are provided from the VTTP, such as a background check performed for a previous application, employment history verification, residence history verification, drug test history, criminal reports, etc. In some examples, a respective verification report for each piece of static data may be stored with the candidate profile data, and may be provided upon request by a prospective employer (e.g., with the candidate's permission) or the candidate. When a candidate applies for a job, the data system 320 may provide the static data along with the job candidate's other qualifications. This static information that has been verified may be identified or marked to provide notice of the verification to a prospective employer. Upon request of the candidate or the prospective employer (along with consent of the candidate), updated non-static data may be requested. Once provided to the data system 320, the updated non-static data may be received by the data system 320 and the digital work wallet 323 may be updated with the new non-static information. During this process, some static verification information may also be received, such as updated employment history for more recent jobs, updated residential history, updated education history, updated certifications or memberships without expiration.

The data in the table below may be used to identify and describe parts of the background cheek process that are important for managing the digital work wallet 323:

| Name | Acronym | Description |
|---|---|---|
| Static Data | SD | Static Data may defined as any data that |
| | | only needs to be verified a single time and |
| | | will always be true, regardless of the time |
| | | elapsed since the data was verified. For |
| | | example, a high school diploma date, once |
| | | verified by a reliable data provider, will |
| | | always be true. |
| Non-Static | NSD | Non-Static Data is defined as any data that |
| Data | | will need to be reverified again after the |
| | | data is originally pulled due to the nature of |
| | | the data and can be deemed “stale data”. |
| | | For example, a drug test can come back |
| | | free of drugs in the report, but is |
| | | immediately stale data because the |
| | | individual can use drugs right after the test |
| | | causing a different result. |
| Clearing House | CHDP | Clearing House Data Provider is a |
| Data Provider | | general term for a data provider that |
| | | provides data that has been deemed |
| | | trustworthy by either a type of |
| | | governing body or otherwise generally |
| | | [symbol] |
| Validated Data | VD | Validated Data is defined at data that is |
| | | outlined to be true and valid by a data |
| | | source that has been deemed |
| | | trustworthy by either a type of |
| | | governing body or otherwise generally |
| | | accepted source of data such as |
| | | [symbol] |
| Non-Static | NSDVTP | The timeframe specifically outlined by |
| Data Validation | | NSD that the data is deemed validated. |
| Time Period | | |
| Expired | ENSD | Expired Non-Static Data will be stored as |
| Non-Static | | Static Data as soon at the NSDVTP ends. |
| Data | | For example, if an accountant let their |
| | | CPA certification lapse, this will be |
| | | shown, but as “lapsed” as part of the |
| | | [symbol] |

[symbol]

indicates data missing or illegible when filed

The data system 320 may use any data from previously ran reports that are supplied to platform and identify the data as Static Data or Non-Static Data. Upon identifying the data, the data system 320 will supply all SD and NSD into their perspective reported areas.

In the case of SD, the data system 320 may identify the CHDP with the corresponding original VD from the CHDP and stamp with “3rd Party Certified” so it can be confidently used in future reports as be reliable.

In the case of NSD, the data system 320 may identify the CHDP with the corresponding original VD from the CHDP and stamp with “3rd Party Certified” so it can be confidently used in future reports as be reliable as long as it falls within the designated NSDVTP. If the NSD passes the NSDVTP, it may be moved to ENSD until is becomes revalidated through another background check from an approved CHDP. NSDVTP vary depending on the type of data that is being inquired.

All VD may then be repurposed by the data owner, the background check requestee (i.e. job seeker, potential renter, etc.) and can used and managed as they deem fit.

The candidate scoring system 310 may include a machine learning inference 312 that calculates scores for various candidates according to their profile for respective jobs. The candidate scoring system 310 may also configured to assign ranking 316 to various candidates based on the scores 314 calculated. As explained above, the probability of hiring a candidate is determined based at least the JSSM, the PCM, and the PSM.

The machine learning inference 312 may determine the JSSM for each job seeker based on their soft skills and hard skills independently. The soft skills may be represented by the PCM and the hard skills are represented by the PSM.

The PCM may be based on a candidate's culture score (CS). The machine learning inference may calculate the CS based on an average score (E) assigned to each of the job seeker's soft skills, required in the job posting, over the past n (e.g., integer of 3 or larger) evaluations. For example:

CS=E₁+E₂+ . . . Eₙ

Using this information, PCM may be calculated as a current CS divided by a maximum CS for the pool of candidates, such as:

$$PCM = \frac{CS}{max ( f ( x ) : x = {CS}_{1} … {CS}_{n} )} * 100$$

where CS₁ . . . CSₙ are cultural scores calculated for the pool of candidates.

The PSM may be based on a candidate's skills score (SS). The SS may be based on an average job seeker self-identified skill score (JS) related to the role or job, an average of two or more previous recruiter-verified skills scores (RS), and an overall skill score (HS) based on the JS and RS. For example, if last two or more hiring-manager-verified skill scores is higher than the JS, then the HS may equal the average of the last two or more hiring-manager-verified skill scores. If the average of the last two or more hiring-manager-verified skill scores is lower than the JS, then the HS may equal the JS. Using this information, the SS may be calculated as follows:

$$SS = ( RS * 0.7 ) + ( JS * 0.2 ) + ( HS * 0.1 )$$

Using this information, PSM may be calculated as a current SS divided by a maximum SS for the pool of candidates, such as:

$$PSM = \frac{SS}{max ( f ( x ) : x = {SS}_{1} … {SS}_{n} )} * 100$$

where SS₁ . . . SSₙ are calculated skills scores for the pool of candidates. Using the calculated PCM and the PSM, the JSSM may be calculated as follows:

JSSM=(PCM*0.35)+(PSM*0.65)

Similar to the candidate scoring system 310, the job scoring system 330 may include a machine learning inference 332 to calculate the scores 334 and ranking 336 with respect to a job position. The recommendation system 340 is configured to define one or more parameters 342 and predict the hiring probability results 344 offer candidates. Based on the calculated scores 314 by the candidate scoring system 310 and the calculated scores 334 by the job scoring system 330, the recommendation system 340 provides recommendation to the candidates and employers.

In some examples, the CMCP 300 may provide the job seeker with a partial or full history of any application(s) that have been submitted inside the ecosystem of the CMCP 300. The job application history may include status updates and various feedback mechanisms, which can be automated and/or entered manually by anyone in the job application or interview process that has appropriate access.

The CMCP 300 may also include a “data co-op” style compensation data analytics tool (CDA). To participate in the CDA, the job seeker must be willing to share certain aspects of their compensation to a larger pool of data with correlating data that will identify the seniority and type of role that is correlated to their compensation, but may allow the identity of the job seeker to remain anonymous.

Various aspects of the CMCP 300 may be shared with other members of the CMCP 300 ecosystem. The level and definitions of which data will be shared may be outlined in a governing policy, such as a “Terms and Conditions” policy but not limited to any document. The level of data available to be shared to other members of the CMCP 300 ecosystem may be controlled and throttled at various degrees at the discretion of the job seeker and the governing documents of the CMCP 300 governing documentation. In some examples, one benefit of the data co-op enabled by the CMCP 300 is that it enhances a value of the job seeker's career along their career journey.

In some examples, to participate in data co-op operated by the CMCP 300, the job seeker may agree to a data contract ownership to maximize the reciprocal value of the job seeker and the CMCP 300 to help manage their career as well as job applications, background checks, and other valuable information in the employment process. The job seeker may retain ownership of their data, and can withdraw it at any time. The data may be designed to be portable from job to job.

In some examples, the CMCP 300 may analyze a job seeker's data (e.g., work history, educational history, certifications/memberships, skills, etc.) and may provide feedback to the job seeker. For example, the CMCP 300 may identify a skill gap for a type of role the job seeker is pursuing. The skill gap may be related to particular experience, a certification, some sort of education, etc. In other examples, the CMCP 300 may generate short and long term goals for a candidate that is pursuing promotion to a higher level job (or a job in a different discipline or industry). The short and long term goals may include types of work experience or roles, education, certifications, etc., that people in the higher level job typically have. In addition, the CMCP 300 may identify an amount of experience, etc., that the job seeker in each role to acquire the requisite skills for the higher level job. In some examples, based on a job seeker acquiring a threshold amount of experience in a role, the CMCP 300 may notify a job seeker that they should consider pursuing the next role on their path to the higher level job. This functionality may be enabled and performed by the machine learning inference 312 of the candidate scoring system 310.

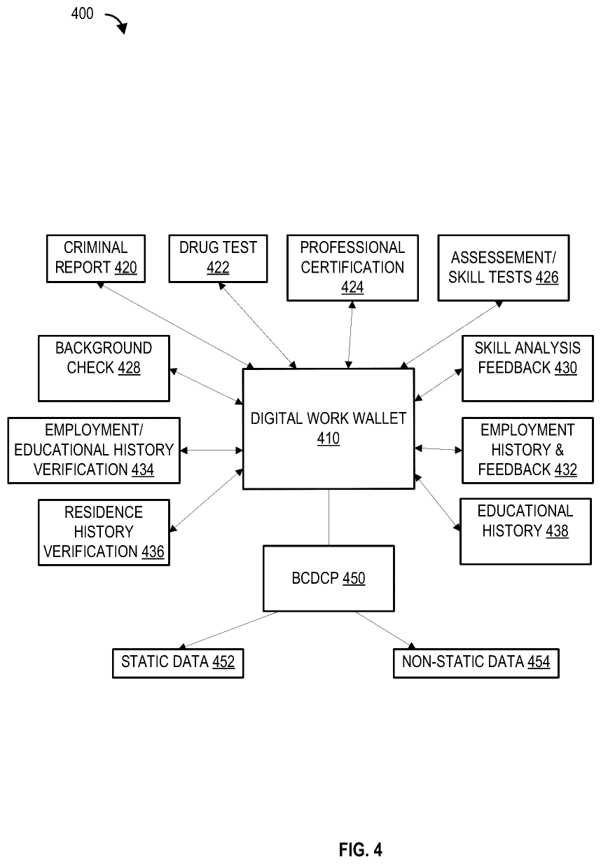

FIG. 4 illustrates a block diagram of a BCDCP system 400, in accordance with embodiments described herein. The BCDCP 122 of FIG. 1, the CMCP 222 and BCDCP 224 of FIG. 2, and/or the CMCP and BCDCP 300 of FIG. 3 may implement the BCDCP 400 in some examples. The BCDCP system 400 may include a BCDCP 450 that is configured to maintain a digital work wallet 410. The digital work wallet 410 may include criminal history reports 420, drug test results 422, professional certification information 424, assessment/skill test results 426, previous background checks 428, skill analysis feedback 430, employment history and feedback 432, employment/educational history verification 434, residence history verification 436, educational history 438, etc., or any combination thereof. It is appreciated that other/additional data may be included in the digital work wallet 410 without departing from the scope of the disclosure. The various components of the BCDCP system 400 may be communicatively associated with the data storage, that stores the digital work wallet 410 and the various included data and information pertaining to the candidate.

Additionally or alternatively, the data and information stored in data storage may be collected from job seekers that agree to participate in the BCDCP 450, and may include information and assessment results with hiring companies participating in the BCDCP 450. In some examples, the job seekers may elect to restrict dissemination of their information to certain employers. In some examples, the job seekers may receive recommendations to apply for open positions that the candidates have a high related qualification score or they can opt-in to recommendations for specific positions that they have an interest in but may not have a competitive qualification score. Job Seekers may also gain visibility into what companies are interested in their skillset and are pursuing them as a candidate.

The BCDCP 450 may generate and maintain the certified digital work wallet 410 including criminal history reports 420, drug test results 422, professional certification information 424, assessment/skill test results 426, previous background checks 428, skill analysis feedback 430, employment history and feedback 432, employment/educational history verification 434, residence history verification 436, educational history 438, etc., or any combination thereof. The professional certification information 424, employment/educational history verification 434, residence history verification 436 may be provided and validated, via a verified trusted third party (VTTP), and/or store the validation in the data storage. In some examples, the job seeker may also provide to the BCDCP 450 criminal history reports 420, drug test results 422, previous background checks 428 ran by previous background check companies, clearing houses, or other VTTPs. This data may be made available by the BCDCP 450 in their digital work wallet 410 and may be provided to an employer at the discretion of the job seeker (e.g., as governed by any local or national governing laws and regulations).

Thus, when the job seeker applies to a job, the professional certification information 424, the employment/educational history verification 434 may be deemed “certified” through a predetermined validation process via a VTTP. In some examples, the data stored in the digital work wallet 410 may be divided into static data 452 and non-static data 454 by the BCDCP 450. Static data 452 may include information that does not change over time, such as previous employment history, previous education history, certifications or memberships without expiration dates, skill assessments, previous residential history. That is, once static data is authenticated, the authentication will remain valid going forward. Non-static data 454 may include information that tends to become outdated, expire become stale, etc., such as criminal history, financial/credit checks, certifications with expiration dates, recent work history after a previous verification check, recent education history after a previous verification check, recent residential history after a previous verification check. For example, a job seeker with an accounting background can enter their CPA certification into the BCDCP 450 through a VTTP. A CPA certification may be considered static data 452, since they will always have the CPA at one point in time. Alternatively, the CPA certification status (e.g., active or inactive), according to the outlined requirements of the CPA governing body may be considered non-static data 454.

In addition, the BCDCP 450 may also receive the verification data or reports associated with the job seeker that are provided from the VTTP, such as the criminal history reports 420, the drug test results 422, the previous background checks 428, residence history verification 436, etc., or any combination thereof, etc. In some examples, a respective verification report for each piece of static data 452 may be stored with the candidate profile data, and may be provided upon request by a prospective employer (e.g., with the candidate's permission) or the candidate. When a candidate applies for a job, the BCDCP 450 may provide the static data 452 along with the job candidate's other qualifications. This static data 452 that has been verified may be identified or marked to provide notice of the verification to a prospective employer. Upon request of the candidate or the prospective employer (along with consent of the candidate), updated non-static data 454 may be requested. Once provided to the BCDCP 450, the updated non-static data 454 may be received by the BCDCP 450 and the digital work wallet 410 may be updated with the new non-static data 454. During this process, some static data 452 verification information may also be received, such as updated employment history for more recent jobs, updated residential history, updated education history, updated certifications or memberships without expiration.

The data system 320 may use any data from previously ran reports that are supplied to platform and identify the data as Static Data or Non-Static Data. Upon identifying the data, the data system 320 will supply all SD and NSD into their perspective reported areas.

In the case of SD, the BCDCP 450 may identify the CHDP with the corresponding original VD from the CHDP and stamp with “3rd Party Certified” so it can be confidently used in future reports as be reliable.

In the case of NSD, the BCDCP 450 may identify the CHDP with the corresponding original VD from the CHDP and stamp with “3rd Party Certified” so it can be confidently used in future reports as be reliable as long as it falls within the designated NSDVTP. If the NSD passes the NSDVTP, it may be moved to ENSD until it becomes revalidated through another background check from an approved CHDP. NSDVTP vary depending on the type of data that is being inquired.

All VD may then be repurposed by the data owner, the background check requestee (i.e. job seeker, potential renter, etc.) and can used and managed as they deem fit.

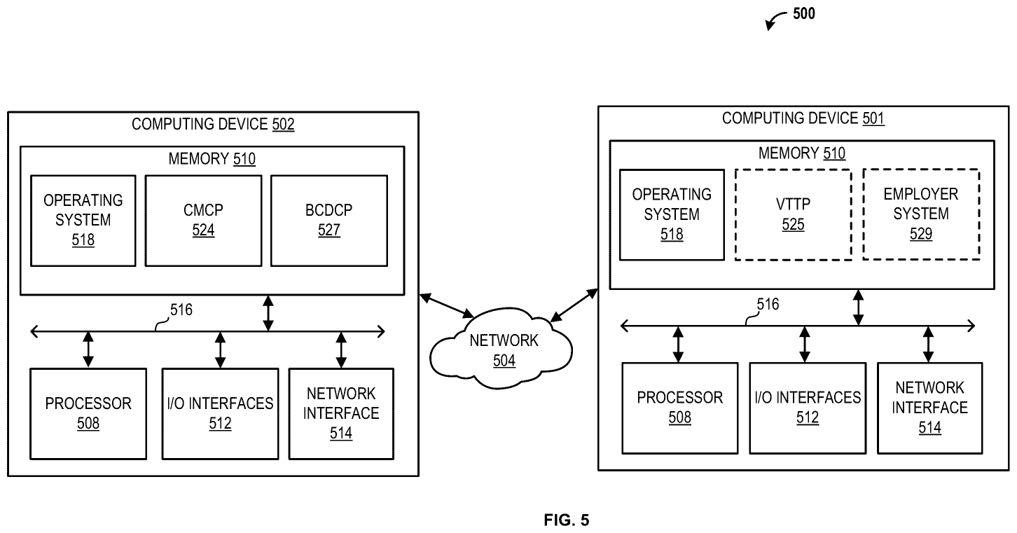

The present methods and systems may be computer-implemented. FIG. 5 is a block diagram depicting a system/environment 500 in accordance with embodiments of the disclosure. The system 500 may include non-limiting examples of a computing device (or server) 501 and a computing device (or server) 502 connected through a network 504. The computing device 501 may implement or host functionality of the employer systems 130, 132, and 134 of FIG. 1 and/or the one or employer systems 230 and/or the ATS 242 of FIG. 2, in some examples. The computing device 502 may implement or host functionality of the CMCP data management and storage system 120 and/or the BCDCP 122 of FIG. 1, the CMCP 222 and/or the BCDCP 223 of FIG. 2, the CMCP and BCDCP 300 of FIG. 3, and/or the BCDCP system 400 of FIG. 4, in some examples. In an aspect, some or all steps of any described method may be performed on a computing device as described herein. The computing device 501 may comprise one or multiple computers configured to store instructions for VTTP 525 and/or employer systems 529. The computing device 502 may comprise one or multiple computers configured to store instructions for the CMCP 524 and/or the BCDCP 527 to implement the functionality of the CMCP and the BCDCP, respectively, described herein. Multiple computing devices 501 and/or 502 may communicate through the network 504.

The computing device 501 and the computing device 502 may be a digital computer that, in terms of hardware architecture, generally includes a processor 508, system memory 510, input/output (I/O) interfaces 512, and network interfaces 514. These components (508, 510, 512, and 514) are communicatively coupled via a local interface 516. The local interface 516 may be, for example, but not limited to, one or more buses or other wired or wireless connections, as is known in the art. The local interface 516 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 508 may be a hardware device for executing software, particularly that stored in system memory 510. The processor 508 may be any custom made or commercially available processor, a central processing unit (CPU), an auxiliary processor among several processors associated with the computing device 501 and the computing device 502, a semiconductor-based microprocessor (in the form of a microchip or chip set), or generally any device for executing software instructions. During operation of the computing device 501 and/or the computing device 502, the processor 508 may execute software stored within the system memory 510, to communicate data to and from the system memory 510, and to generally control operations of the computing device 501 and the computing device 502 pursuant to the software.

The I/O interfaces 512 may be used to receive user input from, and/or for sending system output to, one or more devices or components. User input may be received via, for example, a keyboard and/or a mouse. System output may be output via a display device and a printer (not shown). I/O interfaces 512 may include, for example, a serial port, a parallel port, a Small Computer System Interface (SCSI), an infrared (IR) interface, a radio frequency (RF) interface, and/or a universal serial bus (USB) interface.

The network interface 514 may be used to transmit and receive from the computing device 501 and/or the computing device 502 on the network 504. The network interface 514 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 514 may include address, control, and/or data connections to enable appropriate communications on the network 504.

The system memory 510 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 510 may incorporate electronic, magnetic, optical, and/or other types of storage media. Note that the system memory 510 may have a distributed architecture, where various components are situated remote from one another, but may be accessed by the processor 508.

The software in system memory 510 may include one or more software programs, each of which comprises an ordered listing of executable instructions for implementing logical functions. In the example of FIG. 5, the software in the system memory 510 of the computing device 501 may comprise instructions for the CMCP 524 and/or the BCDCP 527, and a suitable operating system (O/S) 518. In the example of FIG. 5, the software in the system memory 510 of the computing device 502 may comprise instructions for the employer system 529 or the VTTP 525, and a suitable operating system (O/S) 518. The operating system 518 essentially controls the execution of other computer programs and may enable virtualization of the CMCP 524, the BCDCP 527, the VTTP 525, and/or the employer system 529. In some examples, the O/S is a hypervisor configured to host virtual machines or containers to support virtualization.

For purposes of illustration, application programs and other executable program components such as the operating system 518 are shown herein as discrete blocks, although it is recognized that such programs and components may reside at various times in different storage components of the computing device 501 and/or the computing device 502. An implementation of the system/environment 500 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

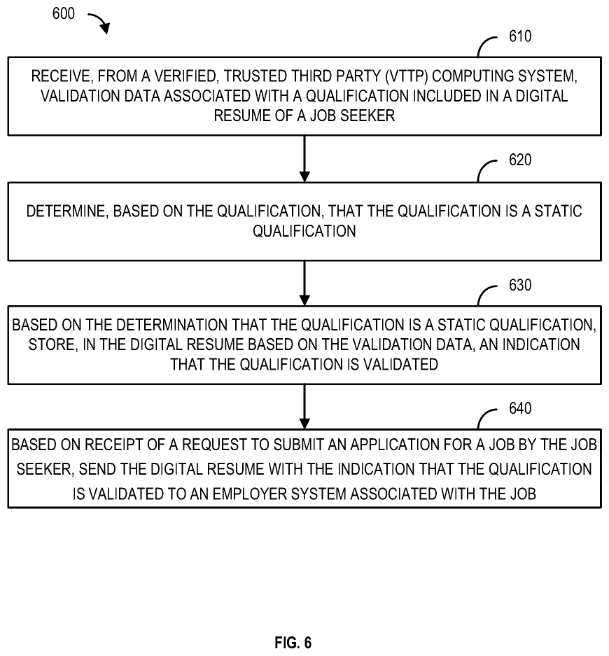

FIG. 6 depicts a flowchart of an example method 600 to manage validation of job seeker qualifications via a BCDCP in accordance with embodiments of the disclosure. The method 600 may be performed in whole or in part by a single computing device, a plurality of computing devices, and the like. For example, the method 500 may be performed by the CMCP data management and storage system 120 and/or the BCDCP 122 of FIG. 1, the CMCP 222 and/or the BCDCP 223 of FIG. 2, the CMCP and BCDCP 300 of FIG. 3, the BCDCP system 400 of FIG. 4, the CMCP 524 and/or the BCDCP 525 hosted on the computing device 501 of FIG. 5, or any combination thereof.

The method 600 may include receiving, from a verified, trusted third party (VTTP) computing system, validation data associated with a qualification included in a digital work wallet of a job seeker, at 610. In some examples, the VTTP system includes the 250 of FIG. 2. The digital work wallet may include the digital work wallet 226 of FIG. 2 and/or the digital work wallet 410 of FIG. 4. In some examples, the validation data includes a report that validates the qualification.

The method 600 may include determining, based on the qualification, that the qualification is a static qualification, at 620. In some examples, the static qualification may include employment history, residential history, educational history, an assessment or skills test, a professional certification, or any combination thereof.

The method 600 may include, based on the determination that the qualification is a static qualification, storing, in the digital work wallet based on the validation data, an indication that the qualification is validated, at 630. In some examples, the indication includes a badge positioned next to the qualification in the digital work wallet. In some examples, the method 600 may further include, based on receipt of permission from the user, storing the validation data in the digital work wallet. In some examples, the method 600 may further include based on a determination that the qualification is a non-static qualification, storing the validation data with an expiration date. In some examples, the non-static qualification may include a drug test, a criminal history report, a background check report, a renewable certification or membership, or any combination thereof.

The method 600 may include, based on receipt of a request to submit an application for a job by the job seeker, sending the digital work wallet with the indication that the qualification is validated to an employer system associated with the job, at 640. In some examples, the method 600 may further include, based on a request from the job seeker, removing the indication from the digital work wallet. The employer system may include the employer systems 130, 132, and 134 of FIG. 1, and/or the one or more employer systems 230 of FIG. 2. The request may be received via one of the candidate devices 110, 112, and 114 of FIG. 1 and/or the one or more candidate devices 210 of FIG. 2.

In some examples, the method 600 may further include, based on a request from the employer system associated with the job, sending, to the VTTP, a request for second validation data for a second qualification of the job seeker. In some examples, the method 600 may further include, based on receipt of the second validation data and based on a determination that the second qualification is a static qualification, storing, in the digital work wallet based on the second validation data, a second indication that the second qualification is validated.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, from a verified, trusted third party (VTTP) computing system, validation data associated with a qualification included in a digital work wallet of a job seeker;
determining, based on the qualification, that the qualification is a static qualification;
based on the determination that the qualification is a static qualification, storing, in the digital work wallet based on the validation data, an indication that the qualification is validated; and
based on receipt of a request to submit an application for a job by the job seeker, sending the digital work wallet with the indication that the qualification is validated to an employer system associated with the job.

2. The method of claim 1, further comprising, based on a determination that the qualification is a non-static qualification, storing the validation data with an expiration date.

3. The method of claim 2, wherein the qualification includes a drug test, a criminal history report, a background check report, a renewable certification or membership, or any combination thereof.

4. The method of claim 1, wherein the qualification includes employment history, residential history, educational history, an assessment or skills test, a professional certification, or any combination thereof.

5. The method of claim 1, wherein the indication includes a badge positioned next to the qualification in the digital work wallet.

6. The method of claim 1, further comprising, based on receipt of permission from the user, storing the validation data in the digital work wallet.

7. The method of claim 1, wherein the validation data includes a report that validates the qualification.

8. The method of claim 7, further comprising, based on a request from the job seeker, removing the indication from the digital work wallet.

9. The method of claim 1, further comprising, based on a request from the employer system associated with the job, sending, to the VTTP, a request for second validation data for a second qualification of the job seeker.

10. The method of claim 9, further comprising, based on receipt of the second validation data and based on a determination that the second qualification is a static qualification, storing, in the digital work wallet based on the second validation data, a second indication that the second qualification is validated.

11. A system comprising:
a verified, trusted third party (VTTP) computing system configured to provide, validation data associated with a qualification included in a digital work wallet of a job seeker; and
a background check data co-op platform (BCDCP) system configured to:
receive the validation data;
determine, based on the qualification, that the qualification is a static qualification;
based on the determination that the qualification is a static qualification, store, in the digital work wallet based on the validation data, an indication that the qualification is validated; and
based on receipt of a request to submit an application for a job by the job seeker, send the digital work wallet with the indication that the qualification is validated to an employer system associated with the job.

12. The system of claim 11, wherein the BCDCP is further configured to, based on a determination that the qualification is a non-static qualification, store the validation data with an expiration date.

13. The system of claim 12, wherein the qualification includes drug test, a criminal history report, a background check report, a renewable certification or membership, or any combination thereof.

14. The system of claim 11, wherein the qualification includes employment history, residential history, educational history, an assessment or skills test, a professional certification, or any combination thereof.

15. The system of claim 11, wherein the indication includes a badge positioned next to the qualification in the digital work wallet.

16. The system of claim 11, wherein the BCDCP is further configured to, based on receipt of permission from the user, store the validation data in the digital work wallet.

17. The system of claim 11, wherein the validation data includes a report that validates the qualification.

18. The system of claim 17, wherein the BCDCP is further configured to, based on a request from the job seeker, remove the indication from the digital work wallet.

19. The system of claim 11, wherein the BCDCP is further configured to, based on a request from the employer system associated with the job, send, to the VTTP, a request for second validation data for a second qualification of the job seeker.

20. The system of claim 19, wherein the BCDCP is further configured to, based on receipt of the second validation data and based on a determination that the second qualification is a static qualification, store, in the digital work wallet based on the second validation data, a second indication that the second qualification is validated.
